(19) United States
(12) Patent Application Publication
(10) Pub. No.: US 2022/0144583 A1
(43) Pub. Date: May 12, 2022

(54) ELEVATOR SYSTEM RESPONSE TO CUSTOM PASSENGER ATTRIBUTES

(71) Applicant: Otis Elevator Company, Farmington, CT (US)

(72) Inventors: Sam Thieu Wong, Bridgeport, CT (US); Vincent Refuerzo Ybanez, West Haven, CT (US)

(21) Appl. No.: 17/091,665

(22) Filed: Nov. 6, 2020

(51) Int. Cl. B66B 1/34; B66B 3/00

(52) U.S. Cl. CPC B66B 1/3407; B66B 2201/405; B66B 1/3461; B66B 3/008

(57) ABSTRACT

A passenger customization system including: a processor; and a memory including computer-executable instructions that, when executed by the processor, cause the processor to perform operations. The operations including: detecting that an individual is within a selected range of an elevator system; obtaining a passenger attribute of the individual; and adjusting a component of the elevator system in response to the passenger attribute.

### BACKGROUND

The subject matter disclosed herein relates generally to the field of elevator systems, and specifically to a method and apparatus for interacting with passengers for elevator cars.

Conventional elevator calls may be submitted by a passenger pressing an elevator button near an elevator door.

### BRIEF SUMMARY

According to an embodiment, a passenger customization system is provided. The passenger customization system including: a processor; and a memory including computer-executable instructions that, when executed by the processor, cause the processor to perform operations. The operations including: detecting that an individual is within a selected range of an elevator system; obtaining a passenger attribute of the individual; and adjusting a component of the elevator system in response to the passenger attribute.

In addition to one or more of the features described herein, or as an alternative, further embodiments may include that the passenger attribute is a visual ability of the individual.

In addition to one or more of the features described herein, or as an alternative, further embodiments may include that the visual ability of the individual is a low visual ability.

In addition to one or more of the features described herein, or as an alternative, further embodiments may include that the adjusting the component of the elevator system in response to the passenger attribute further includes: activating a speaker of an elevator call device.

In addition to one or more of the features described herein, or as an alternative, further embodiments may include that the adjusting the component of the elevator system in response to the passenger attribute further includes: activating a microphone of an elevator call device.

In addition to one or more of the features described herein, or as an alternative, further embodiments may include that the adjusting the component of the elevator system in response to the passenger attribute further includes: activating a speaker within an elevator car.

In addition to one or more of the features described herein, or as an alternative, further embodiments may include that the adjusting the component of the elevator system in response to the passenger attribute further includes: activating a microphone within an elevator car.

In addition to one or more of the features described herein, or as an alternative, further embodiments may include that the adjusting the component of the elevator system in response to the passenger attribute further includes: adjusting a display device within an elevator car.

In addition to one or more of the features described herein, or as an alternative, further embodiments may include that the adjusting the component of the elevator system in response to the passenger attribute further includes: adjusting a display device within an elevator car to increase a contrast of the display device based on the low visual ability.

In addition to one or more of the features described herein, or as an alternative, further embodiments may include that the passenger attribute is the entertainment preferences of the individual.

In addition to one or more of the features described herein, or as an alternative, further embodiments may include that the adjusting the component of the elevator system in response to the passenger attribute further includes: adjusting a display device within the elevator car to display the entertainment preference of the individual.

In addition to one or more of the features described herein, or as an alternative, further embodiments may include that the obtaining the passenger attribute of the individual further includes: receiving the passenger attribute from a mobile device of the individual.

In addition to one or more of the features described herein, or as an alternative, further embodiments may include that the detecting that the individual is within the selected range of the elevator system further includes: detecting a distance between a wireless access protocol device and mobile device of the individual.

In addition to one or more of the features described herein, or as an alternative, further embodiments may include that the obtaining the passenger attribute of the individual further includes: receiving the passenger attribute from the mobile device.

In addition to one or more of the features described herein, or as an alternative, further embodiments may include that the detecting that the individual is within the selected range of the elevator system further includes: receiving a credential from a key card or mobile device at a turnstile lock attached to a turnstile.

In addition to one or more of the features described herein, or as an alternative, further embodiments may include that the obtaining the passenger attribute of the individual further includes: receiving the passenger attribute from the key card or the mobile device.

In addition to one or more of the features described herein, or as an alternative, further embodiments may include that the obtaining the passenger attribute of the individual further includes: receiving the passenger attribute from a passenger customization database.

In addition to one or more of the features described herein, or as an alternative, further embodiments may include that the operations further include: detecting a second individual in the elevator car; and displaying entertainment preferences of the individual prior to the entertainment preferences of the second individual if the individual is exiting the elevator car prior to the second individual.

In addition to one or more of the features described herein, or as an alternative, further embodiments may include that the operations further include: detecting a second individual in the elevator car; and displaying entertainment preferences of the individual simultaneously to the entertainment preferences of the second individual.

According to another embodiment a computer program product embodied on a non-transitory computer readable medium is provided. The computer program product including instructions that, when executed by a processor, cause the processor to perform operations including: detecting that an individual is within a selected range of an elevator system; obtaining a passenger attribute of the individual; and adjusting a component of the elevator system in response to the passenger attribute.

Technical effects of embodiments of the present disclosure include customizing an individual's use of an elevator system based upon previously saved passenger attributes.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The present disclosure is illustrated by way of example and not limited in the accompanying figures in which like reference numerals indicate similar elements.

FIG. 1 is a schematic illustration of an elevator system that may employ various embodiments of the present disclosure;

FIG. 2 illustrates a schematic view of a passenger customization system, in accordance with an embodiment of the disclosure; and

FIG. 3 is a flow chart of method of operating one or more elevator systems, in accordance with an embodiment of the disclosure.

### DETAILED DESCRIPTION

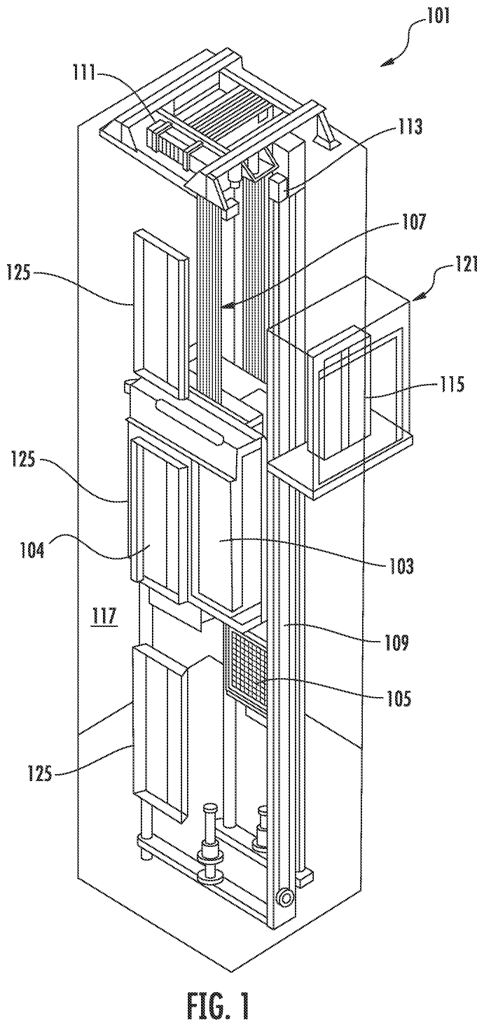

FIG. 1 is a perspective view of an elevator system 101 including an elevator car 103, a counterweight 105, a tension member 107, a guide rail 109, a machine 111, a position reference system 113, and a controller 115. The elevator car 103 and counterweight 105 are connected to each other by the tension member 107. The tension member 107 may include or be configured as, for example, ropes, steel cables, and/or coated-steel belts. The counterweight 105 is configured to balance a load of the elevator car 103 and is configured to facilitate movement of the elevator car 103 concurrently and in an opposite direction with respect to the counterweight 105 within an elevator shaft 117 and along the guide rail 109.

The tension member 107 engages the machine 111, which is part of an overhead structure of the elevator system 101. The machine 111 is configured to control movement between the elevator car 103 and the counterweight 105. The position reference system 113 may be mounted on a fixed part at the top of the elevator shaft 117, such as on a support or guide rail, and may be configured to provide position signals related to a position of the elevator car 103 within the elevator shaft 117. In other embodiments, the position reference system 113 may be directly mounted to a moving component of the machine 111, or may be located in other positions and/or configurations as known in the art. The position reference system 113 can be any device or mechanism for monitoring a position of an elevator car and/or counterweight, as known in the art. For example, without limitation, the position reference system 113 can be an encoder, sensor, or other system and can include velocity sensing, absolute position sensing, etc., as will be appreciated by those of skill in the art.

The controller 115 is located, as shown, in a controller room 121 of the elevator shaft 117 and is configured to control the operation of the elevator system 101, and particularly the elevator car 103. For example, the controller 115 may provide drive signals to the machine 111 to control the acceleration, deceleration, leveling, stopping, etc. of the elevator car 103. The controller 115 may also be configured to receive position signals from the position reference system 113 or any other desired position reference device. When moving up or down within the elevator shaft 117 along guide rail 109, the elevator car 103 may stop at one or more landings 125 as controlled by the controller 115. Although shown in a controller room 121, those of skill in the art will appreciate that the controller 115 can be located and/or configured in other locations or positions within the elevator system 101. In one embodiment, the controller may be located remotely or in the cloud.

The machine 111 may include a motor or similar driving mechanism. In accordance with embodiments of the disclosure, the machine 111 is configured to include an electrically driven motor. The power supply for the motor may be any power source, including a power grid, which, in combination with other components, is supplied to the motor. The machine 111 may include a traction sheave that imparts force to tension member 107 to move the elevator car 103 within elevator shaft 117.

Although shown and described with a roping system including tension member 107, elevator systems that employ other methods and mechanisms of moving an elevator car within an elevator shaft may employ embodiments of the present disclosure. For example, embodiments may be employed in ropeless elevator systems using a linear motor or pinched wheel propulsion to impart motion to an elevator car. Embodiments may also be employed in ropeless elevator systems using a hydraulic lift to impart motion to an elevator car. FIG. 1 is merely a non-limiting example presented for illustrative and explanatory purposes.

In other embodiments, the system comprises a conveyance system that moves passengers between floors and/or along a single floor. Such conveyance systems may include escalators, people movers, etc. Accordingly, embodiments described herein are not limited to elevator systems, such as that shown in FIG. 1. In one example, embodiments disclosed herein may be applicable conveyance systems such as an elevator system 101 and a conveyance apparatus of the conveyance system such as an elevator car 103 of the elevator system 101. In another example, embodiments disclosed herein may be applicable conveyance systems such as an escalator system and a conveyance apparatus of the conveyance system such as a moving stair of the escalator system.

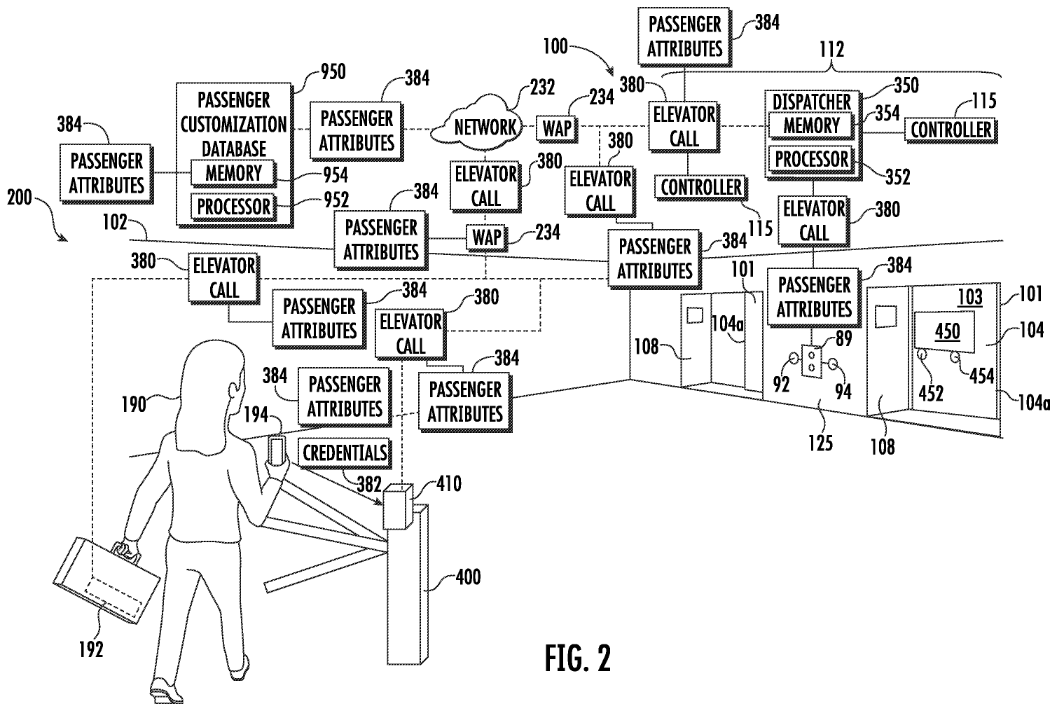

The elevator system 101 also includes one or more elevator doors 104. The elevator door 104 may be integrally attached to the elevator car 103. There may also be an elevator door 104 located on a landing 125 of the elevator system 101 (see FIG. 2). Embodiments disclosed herein may be applicable to both an elevator door 104 integrally attached to the elevator car 103 and/or a landing elevator door 104a located on a landing 125 of the elevator system 101. The elevator doors 104, 104a opens to allow passengers to enter and exit the elevator car 103.

Referring now to FIG. 2, with continued reference to FIG. 1, a passenger customization system 200 is illustrated, in accordance with an embodiment of the present disclosure. It should be appreciated that, although particular systems are separately defined in the schematic block diagrams, each or any of the systems may be otherwise combined or separated via hardware and/or software.

As illustrated in FIG. 2, a building elevator system 100 within a building 102 may include multiple different individual elevator systems 101 organized in an elevator bank 112. The elevator systems 101 each include an elevator car 103 (one elevator car 103 is not shown in FIG. 2 for simplicity). It is understood that while two elevator systems 101 are utilized for exemplary illustration, embodiments disclosed herein may be applied to building elevator systems 100 having one or more elevator systems 101. Further, the elevator systems 101 illustrated in FIG. 2 are organized into an elevator bank 112 for ease of explanation but it is understood that the elevator systems 101 may be organized into one or more elevator banks 112. Each of the elevator banks 112 may contain one or more elevator systems 101. Each of the elevator banks 112 may also be located on the same or different landings 125.

There may be an elevator call device 89 located proximate the elevator systems 101 on the landing 125. The elevator call device 89 transmits an elevator call 380 to a dispatcher 350 of the building elevator system 100. The elevator call 380 may include a destination for the individual 190 (i.e., passenger). It should be appreciated that, although the dispatcher 350 is separately defined in the schematic block diagrams, the dispatcher 350 may be combined via hardware and/or software in any controller 115 or other device. The elevator call 380 may include the source (i.e., the individual 190 who made the elevator call 380) of the elevator call 380. The elevator call device 89 may include a destination entry option that includes the destination of the elevator call 380. The elevator call device 89 may be a push button and/or a touch screen and may be activated manually or automatically. For example, the elevator call 380 may be sent by an individual 190 via the elevator call device 89.

The elevator call device 89 may also include or be in communication with a speaker 92 and a microphone 94. The speaker 92 is configured to emit sound and the microphone 94 is configured to receive sound.

A mobile device 192 may also be configured to transmit an elevator call 380. The individual 190 may be in possession of the mobile device 192 to transmit the elevator call 380.

The mobile device 192 may be a smart phone, smart watch, tablet, laptop, or any other mobile device known to one of skill in the art. The mobile device 192 may be configured to transmit the elevator call 380 through a computing network 232 to the dispatcher 350 or directly to the dispatcher 350. The elevator call 380 may be transmitted when the mobile device 192 is detected within a selected range (i.e., distance) of the elevator system 101. The distance between the mobile device 192 and the elevator system 101 may be determined based on a received signal strength (e.g., received signal strength indicator (RSSI)) between the mobile device 192 and a wireless access protocol device (WAP) 234. The distance between the mobile device 192 and the elevator system 101 may be determined based on when the mobile device is used to activate a turnstile lock 410. The mobile device 192 may communicate to the computing network 232 through the WAP 234 using short-range wireless protocols. Short-range wireless protocol may include, but are not limited to, Bluetooth, BLE, Wi-Fi, HaLow (801.11ah), zWave, ZigBee, or Wireless M-Bus. Alternatively, the mobile device 192 may communicate directly with the computing network 232 or the dispatcher 350 using long-range wireless protocols. Long-range wireless protocols may include, but are not limited to, cellular, LTE (NB-IoT, CAT M1), LoRa, satellite, Ingenu, or SigFox.

The controllers 115 can be combined, local, remote, cloud, etc. The dispatcher 350 may be local, remote, cloud, etc. The dispatcher 350 is in communication with the controller 115 of each elevator system 101. Alternatively, there may be a single controller that is common to all of the elevator systems 101 and controls all of the elevator system 101, rather than two separate controllers 115, as illustrated in FIG. 2. The dispatcher 350 may be a ‘group’ software that is configured to select the best elevator car 103 to be assigned to the elevator call 380. The dispatcher 350 manages the elevator call devices 89 related to the elevator bank 112.

The dispatcher 350 is configured to control and coordinate operation of multiple elevator systems 101. The dispatcher 350 may be an electronic controller including a processor 352 and an associated memory 354 comprising computer-executable instructions that, when executed by the processor 352, cause the processor 352 to perform various operations. The processor 352 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 354 may be but is not limited to a random access memory (RAM), read only memory (ROM), or other electronic, optical, magnetic or any other computer readable medium.

The dispatcher 350 is in communication with the elevator call devices 89 of the building elevator system 100. The dispatcher 350 is configured to receive the elevator call 380 transmitted from the elevator call device 89 and/or the mobile device 192. The dispatcher 350 is configured to manage the elevators calls 380 coming in from the elevator call device 89, and/or mobile devices 192 then command one or more elevator systems 101 to respond to elevator call 380.

The passenger customization system 200 may also include a passenger customization database 950. The passenger customization system 200 may be located local or remote to the elevator system 101.

The passenger customization database 950 may be a computing device including a processor 952 and an associated memory 954 comprising computer-executable instructions that, when executed by the processor 952, cause the processor 952 to perform various operations. The processor 952 may be, but is not limited to, a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory 954 may be but is not limited to a random access memory (RAM), read only memory (ROM), or other electronic, optical, magnetic or any other computer readable medium. Passenger attributes 384 may be stored on the passenger customization database 950 or more specifically in the memory 954 of the passenger customization database 950.

Passenger attributes 384 are information pertaining to the individual 190 that may help customize a ride on the elevator car 103 for the individual 190. Passenger attributes 384 may include but are not limited to entertainment preferences, spoken language, and visual ability of the individual 190. In one example, the entertainment preference may be what the individual 190 desires to see and/or hear while the individual 190 rides in the elevator car 103. For example, entertainment preferences may include the news, weather, traffic, train times, sports scores, building information, stock market quotes, instructions or any other information known to one of skill in the art. The entertainment preferences may be displayed on a display device 450 located within or near the elevator car 103. The display can be a traditional screen-type display, such as, for example, a computer monitor or television. The display device 450 may include a speaker configured to provide audible sound and/or verbal instructions. If there are multiple individuals 190 present in the elevator car 103 simultaneously, the duration and order of each type of information (i.e., entertainment preferences) conveyed may be based on a calculated remaining travel time of each individual 190. For example, if a first individual 190 is getting off the elevator car 103 first then the information of the first individual 190 may be conveyed prior to the information of any other individual 190 in the elevator car 103. Thus, the information may be conveyed in the order that the individuals 190 are expected to exit the elevator car 103. If there are multiple individuals 190 in the elevator car 103 simultaneously, all of their information (i.e., entertainment preferences) may also be conveyed visually and/or audibly at the same time.

The spoken language may be the language that the individuals 190 speaks. Once the spoken language is known, then the display device 450 may be adjusted to properly display entertainment preferences in the spoken language of the individual 190 and/or the speaker 452 within the elevator car may emit audio in the spoken language of the individual 190.

The visual ability of the individual 190 may include how well the individual 190 can see. For example, if the individual 190 cannot see that well the individual 190 may have low visual ability, the individual 190 may be greeted by verbal communication from the speaker 92 and rather than entering a destination on the elevator call device 89 the dispatcher 350 may ask the individual 190 “are you going up or down” through the speaker 92 and the individual 190 may provide an answer via the microphone 94. The elevator call device 89 may then transmit an elevator call 380 to the dispatcher 350 based on the answer provided by the individual 190. In another example, if the individual 190 cannot see that well (i.e., low visual ability), a display device 450 in or near the elevator car 103 may be adjusted to help the individual see and read the display device 450 better. For example, the contrast on the display device 450 may be increased to help an individual 190 with low visual ability see and read the display device 450 better. In another example, if the individual 190 cannot see that well (i.e., low visual ability), the entertainment preference may be provided via the speaker 452 within the elevator car 103. For example, the news, weather, traffic, sports scores, building information, stock market quotes, or instructions may be read aloud via the speaker 452 within the elevator car 103. In another example, the speaker 452 may ask what landing 125 (e.g., floor) the individual 190 is traveling to. Then a microphone 454 may activate within the elevator car 103 to receive an answer from the individual 190.

The passenger customization system 200 may also include a turnstile 400 and a turnstile lock 410. In order to actuate/unlock the turnstile 400 an individual 190 must use a key card 194 or the mobile device 192. A credential 382 assigned to the individual 190 may be stored on the key card 194 and/or the mobile device 192. The key card 194 and/or the mobile device 192 may be placed proximate the turnstile 400 lock to pass a credential 382 to the turnstile lock 410 in order to unlock the turnstile 400. The turnstile 400 will only unlock if the credential 382 is authorized to unlock the turnstile 400.

The key card 194 and/or the mobile device 192 may also pass passenger attributes 384 with the credential 382. The passenger attributes 384 may be stored on the key card 194, on the mobile device 192, and/or in the passenger customization database 950. For example, if the passenger attribute 384 are not stored on the key card 194 or the mobile device 192 then a query may be made to the passenger customization database 950 to obtain the passenger attributes 384. The dispatcher 350 may send the query to the passenger customization database 950 upon receiving an elevator call 380.

The individual 190 may have the ability to adjust the passenger attributes 384 via the mobile device 192. The passenger attributes 384 may be pre-programed, adjusted advance of interacting with the elevator system 101 or adjusted while interacting with the elevator system 101. For example, the individual 190 may adjust the passenger attributes 384 while in the elevator car 103 to adjust what they are viewing on the display device 450 in the elevator car 103. Additionally, the passenger attributes 384 may be configured to change with time, location, and other variables. For example, the individual 190 may want to review news in the morning and sports in the afternoon on the display device 450 in the elevator car 103.

The passenger attributes 384 may then be transferred, along with an elevator call 380 to the dispatcher 350 either directly or through the WAP 234 and the network 232.

In another embodiment, the passenger attributes may be detected via a visual sensor that can detect an individual 190 with a visual impairment (e.g., a walking stick, ID card, or some other visual identifier), an audio sensor (e.g. microphone that picks up an individual 190 walking with crutches or a wheelchair), or other types of sensors. The sensor may be located in an elevator lobby proximate the elevator system 101.

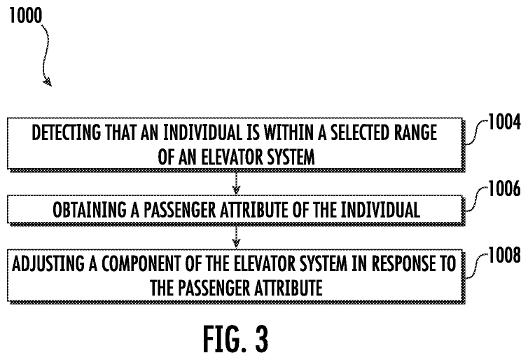

Referring now to FIG. 3, with continued reference to FIGS. 1-2, a flow chart of method 1000 of operating one or more elevator systems 101 is illustrated, in accordance with an embodiment of the disclosure. In an embodiment, the method 1000 is performed by the passenger customization system 200 or the dispatcher 350 of FIG. 2.

At block 1004, it is detected that an individual 190 is within a selected range of an elevator system 101. The individual 190 may be detected within a selected range of an elevator system 101 by detecting a distance between a WAP 234 and a mobile device 192 of the individual 190. The individual 190 may be detected within a selected range of an elevator system 101 by: receiving a credential 382 from a key card 194 or mobile device 192 at a turnstile lock 410 attached to a turnstile 400. Alternatively, the individual 190 may be detected by some other sensing mechanism, such as, for example a camera configured to identify the individual through facial recognition.

The method 1000 may further include that an elevator call 380 is transmitted to the elevator system 101. The elevator call 380 may be transmitted when the individual 190 is detected within the selected range.

At block 1006, a passenger attribute 384 of the individual 190 is obtained. The passenger attribute 384 of the individual 190 may be obtained by: receiving the passenger attribute 384 from a mobile device 192 of the individual 190, receiving the passenger attribute 384 from the key card 194 or receiving the passenger attribute 384 from a passenger customization database 950.

At block 1008, a component of the elevator system 101 is adjusted in response to the passenger attribute. In an embodiment, the passenger attribute 384 is the visual ability of the individual 190. In another embodiment, the visual ability of the individual is a low visual ability. The component of the elevator system 101 may be a speaker 92 of an elevator call device 89, a microphone of the elevator call device 89, a display device 450 within the elevator car 103, a speaker 452 within the elevator car 103, and/or a microphone 454 within the elevator car 103.

The component of the elevator system 101 may be adjusted in response to the passenger attribute 384 by activating a speaker 92 of an elevator call device 89. For example, the speaker 92 may be activated to ask the individual 190 “going up or down?”.

The component of the elevator system 101 may be adjusted in response to the passenger attribute 384 by activating a microphone 94 of an elevator call device 89. For example, the microphone 94 may be activated to listen to the individual 190 answer “up or down”.

The component of the elevator system 101 may be adjusted in response to the passenger attribute 384 by activating a speaker 452 within the elevator car 103. For example, the speaker 452 may be activated to ask the individual 190 “what floor?”.

The component of the elevator system 101 may be adjusted in response to the passenger attribute 384 by activating a microphone 254 within the elevator car 103. For example, the microphone 254 may be activated to listen to the individual 190 answer with the floor number.

The component of the elevator system 101 may be adjusted in response to the passenger attribute 384 by adjusting a display device 450 within the elevator car 103.

The component of the elevator system 101 may be adjusted in response to the passenger attribute 384 by adjusting a display device 450 within the elevator car 103 to increase a contrast of the display device 450 based on the low visual ability of the individual 190.

In an embodiment, the passenger attribute 384 is the entertainment preferences of the individual 190. The component of the elevator system 101 may be adjusted in response to the passenger attribute 384 by adjusting a display device 450 within the elevator car 103 to display the entertainment preference of the individual 190.

While the above description has described the flow process of FIG. 3 in a particular order, it should be appreciated that unless otherwise specifically required in the attached claims that the ordering of the steps may be varied.

The present invention may be a system, a method, and/or a computer program product at any possible technical detail level of integration. The computer program product may include a computer readable storage medium (or media) having computer readable program instructions thereon for causing a processor to carry out aspects of the present invention.

As described above, embodiments can be in the form of processor-implemented processes and devices for practicing those processes, such as processor. Embodiments can also be in the form of computer program code (e.g., computer program product) containing instructions embodied in tangible media (e.g., non-transitory computer readable medium), such as floppy diskettes, CD ROMs, hard drives, or any other non-transitory computer readable medium, wherein, when the computer program code is loaded into and executed by a computer, the computer becomes a device for practicing the embodiments. Embodiments can also be in the form of computer program code, for example, whether stored in a storage medium, loaded into and/or executed by a computer, or transmitted over some transmission medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an device for practicing the exemplary embodiments. When implemented on a general-purpose microprocessor, the computer program code segments configure the microprocessor to create specific logic circuits.

The term “about” is intended to include the degree of error associated with measurement of the particular quantity and/or manufacturing tolerances based upon the equipment available at the time of filing the application.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

Those of skill in the art will appreciate that various example embodiments are shown and described herein, each having certain features in the particular embodiments, but the present disclosure is not thus limited. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A passenger customization system comprising:
a processor; and
a memory comprising computer-executable instructions that, when executed by the processor, cause the processor to perform operations, the operations comprising:
detecting that an individual is within a selected range of an elevator system;
obtaining a passenger attribute of the individual; and
adjusting a component of the elevator system in response to the passenger attribute.

2. The passenger customization system of claim 1, wherein the passenger attribute is a visual ability of the individual.

3. The passenger customization system of claim 2, wherein the visual ability of the individual is a low visual ability.

4. The passenger customization system of claim 1, wherein the adjusting the component of the elevator system in response to the passenger attribute further comprises:
activating a speaker of an elevator call device.

5. The passenger customization system of claim 1, wherein the adjusting the component of the elevator system in response to the passenger attribute further comprises:
activating a microphone of an elevator call device.

6. The passenger customization system of claim 1, wherein the adjusting the component of the elevator system in response to the passenger attribute further comprises:
activating a speaker within an elevator car.

7. The passenger customization system of claim 1, wherein the adjusting the component of the elevator system in response to the passenger attribute further comprises:
activating a microphone within an elevator car.

8. The passenger customization system of claim 1, wherein the adjusting the component of the elevator system in response to the passenger attribute further comprises:
adjusting a display device within an elevator car.

9. The passenger customization system of claim 3, wherein the adjusting the component of the elevator system in response to the passenger attribute further comprises:
adjusting a display device within an elevator car to increase a contrast of the display device based on the low visual ability.

10. The passenger customization system of claim 1, wherein the passenger attribute is the entertainment preferences of the individual.

11. The passenger customization system of claim 10, wherein the adjusting the component of the elevator system in response to the passenger attribute further comprises:
adjusting a display device within the elevator car to display the entertainment preference of the individual.

12. The passenger customization system of claim 1, wherein the obtaining the passenger attribute of the individual further comprises:
receiving the passenger attribute from a mobile device of the individual.

13. The passenger customization system of claim 1, wherein the detecting that the individual is within the selected range of the elevator system further comprises:
detecting a distance between a wireless access protocol device and mobile device of the individual.

14. The passenger customization system of claim 13, wherein the obtaining the passenger attribute of the individual further comprises:
receiving the passenger attribute from the mobile device.

15. The passenger customization system of claim 1, wherein the detecting that the individual is within the selected range of the elevator system further comprises:
receiving a credential from a key card or mobile device at a turnstile lock attached to a turnstile.

16. The passenger customization system of claim 15, wherein the obtaining the passenger attribute of the individual further comprises:
receiving the passenger attribute from the key card or the mobile device.

17. The passenger customization system of claim 1, wherein the obtaining the passenger attribute of the individual further comprises:
receiving the passenger attribute from a passenger customization database.

18. The passenger customization system of claim 11, wherein the operations further comprise:
detecting a second individual in the elevator car; and
displaying entertainment preferences of the individual prior to the entertainment preferences of the second individual if the individual is exiting the elevator car prior to the second individual.

19. The passenger customization system of claim 11, wherein the operations further comprise:
detecting a second individual in the elevator car; and
displaying entertainment preferences of the individual simultaneously to the entertainment preferences of the second individual.

20. A computer program product embodied on a non-transitory computer readable medium, the computer program product including instructions that, when executed by a processor, cause the processor to perform operations comprising:
detecting that an individual is within a selected range of an elevator system;
obtaining a passenger attribute of the individual; and
adjusting a component of the elevator system in response to the passenger attribute.
